(19) United States
(12) Patent Application Publication
(10) Pub. No.: US 2012/0179600 A1
(43) Pub. Date: Jul. 12, 2012

(54) Transfer Station and End to End Process

(75) Inventors: Walter McGaha, Charlotte, NC (US); Terry L. Lewis, Alexis, NC (US)

(73) Assignee: Bank of America Corporation, Charlotte, NC (US)

(21) Appl. No.: 12/986,486

(22) Filed: Jan. 7, 2011

(51) Int. Cl. G06Q 40/00

(52) U.S. Cl. 705/39

(57) ABSTRACT

A system and method for processing ACH transactions is disclosed. In particular embodiments, a method includes receiving one or more files from a client sender, each of the one or more files including a transaction request for one or more ACH transactions. The method also includes storing the one or more files in a memory. The method further includes selecting a file from the received one or more files stored in the memory. The method also includes selecting an ACH processor from a plurality of ACH processors to receive the selected file. The method further includes translating the selected file into a format processable by the selected ACH processor and transmitting the translated file to the selected ACH processor.

### TECHNICAL FIELD OF THE INVENTION

The present disclosure relates generally to transaction processing, and more particularly to a transfer station and end to end process.

### BACKGROUND OF THE INVENTION

Automated Clearing House transactions comprise a significant portion of financial transactions. The systems currently in place to process these transactions may include disparate and distinct operating systems, communication protocols, file formats, and/or networks. Thus, interconnectivity between various platforms and systems, while allowing for scalability and backwards compatibility remains a challenge.

### SUMMARY OF THE INVENTION

In accordance with particular embodiments of the present disclosure, the disadvantages and problems associated with a transfer station and end to end processes have been substantially reduced or eliminated.

In accordance with a particular embodiment of the present disclosure, a method includes receiving one or more files from a client sender, each of the one or more files including a transaction request for one or more ACH transactions. The method also includes storing the one or more files in a memory. The method further includes selecting a file from the received one or more files stored in the memory. The method also includes selecting an ACH processor from a plurality of ACH processors to receive the selected file. The method further includes translating the selected file into a format processable by the selected ACH processor and transmitting the translated file to the selected ACH processor.

In accordance with another embodiment of the present disclosure, a system includes a memory operable to store one or more files, each of the files including a transaction request for one or more ACH transactions. The system also includes a file processor operable to receive a file from a client sender and select a file from the received file and the plurality of files stored in the memory. The file processor is further operable to select an ACH processor from a plurality of ACH processors to receive the selected file. Additionally, the file processor is operable to translate the selected file into a format processable by the selected ACH processor and transmit the translated file to the selected ACH processor.

In accordance with yet another embodiment of the present disclosure, a non-transitory computer readable medium is encoded with logic, and the logic is operable, when executed on a processor to receive one or more files from a client sender, each of the one or more files including a transaction request for one or more ACH transactions. The logic is further operable to store the one or more files in a memory. The logic is also operable to select a file from the received one or more files stored in the memory. The logic is also operable to select an ACH processor from a plurality of ACH processors to receive the selected file. The logic is further operable to translate the selected file into a format processable by the selected ACH processor and transmit the translated file to the selected ACH processor.

Technical advantages provided by particular embodiments of the present disclosure include performing protocol, file format, and interconnectivity translational operations. For example, particular embodiments enable an ACH processor to be agnostic with respect to the protocol, system and type of file sent by a client sender. Transactions and/or applications processed by and/or interfacing with an ACH processing system may include a Demand Deposit Application (DDA), information reporting, web channels, viewing and reporting transactions, and/or ACH origination. Moreover, a transfer station may be provided that processes a received file to determine whether the received file conforms to NACHA regulations. A transfer station may further provide in-clearing a received file through inter-partner clearing within PARITER processing, “on-us” DDA processing, and/or out-clearing through the Federal Reserve or EPN processing. ACH processing may involve interfacing with numerous other heterogeneous applications. Utilizing an ACH processing system, existing applications operated by a client sender may coexist with any ACH processor. Moreover, a transfer station enables transparency across all non-ACH applications. As a result, a transfer station may eliminate point-to-point connectivity between a plurality of ACH processors and all interfacing systems; thus contributing to a more flexible architecture that supports customer and application migrations to their respective target end states more readily. In this way, non-ACH applications operated by a client sender may be agnostic with respect to which particular ACH processor handles a particular transaction initiated by a client sender.

Further, in particular embodiments, a transfer station leverages middleware between non-ACH applications and an ACH processor. For example, in some embodiments, a transfer station represents an overarching umbrella framework that leverages lower-level middleware used to interface between client systems and an ACH processor. In particular embodiments, a transfer station may operate to ensure that transactions and/or a file are not lost. An ACH processing system may also be agnostic with respect to the communication protocols utilized by components of an ACH processing system. For example, a transfer station may communicate with other components an ACH processing system via file transfer protocol (FTP), secure file transfer protocol (secure FTP), Network Data Mover protocol (NDM), and/or any other host-to-host connection. Moreover, a transfer station decouples each ACH processor entity from semantics internal to client senders.

In some embodiments, a transfer station includes a file processor, which may route a received file to an appropriate ACH processor and ensures that no file gets lost. Previously, applications operated by a client sender would transfer a file to an

ACH system without receiving any type of confirmation or acknowledgment. However, this type of arrangement does not scale in situations in which there are numerous types of applications and numerous types of ACH processors. Utilizing an ACH processing system, a client sender transmits a file to a transfer station, which determines how to interact with an ACH processor and/or other client senders. A transfer station determines intrinsic data or metadata associated with a file, what type of data a file represents, and an appropriate component of an ACH processing system to process a file. Thus, particular embodiments of an ACH processing system buffers the need for change between any application and an ACH processor. Moreover, an ACH processing system allows for local processing to transform data into an appropriate format suitable for processing by an ACH processor. As a result, particular embodiments of the present disclosure may provide numerous technical advantages. Nonetheless, particular embodiments may provide some, none, or all of these technical advantages, and may provide additional technical advantages.

### BRIEF DESCRIPTION OF THE DRAWINGS

FIG. 1 illustrates an ACH processing system in accordance with particular embodiments of the present disclosure;

FIG. 2 illustrates a transfer station shown in FIG. 1 in more detail, according to particular embodiments of the present disclosure; and

FIG. 3 is a flow diagram illustrating a particular operation of the system of FIG. 1 in accordance with particular embodiments of the present disclosure.

### DETAILED DESCRIPTION OF THE INVENTION

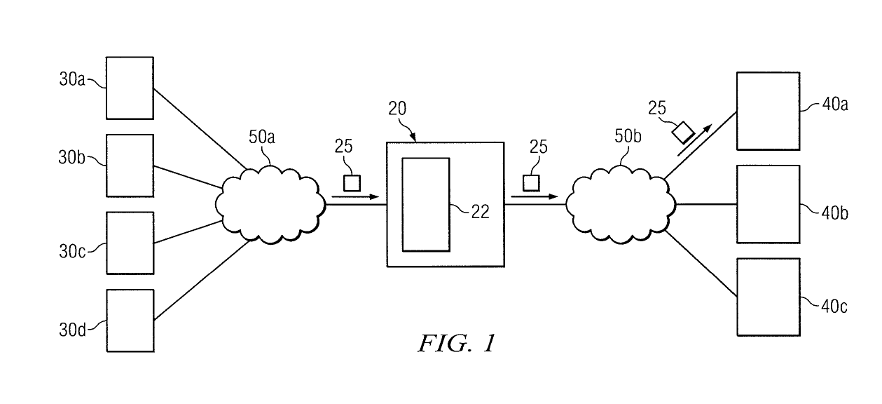

A system and method for a transfer station and end to end process is disclosed. FIG. 1 illustrates an ACH processing system 10 that includes transfer station 20, client senders 30a-d and ACH processor 40. In particular embodiments, ACH processing system 10 enables Automatic Clearing House (ACH) processing from one or more types of client senders 30 to one or more types of ACH processors 40. By providing for a transfer station 20 and/or file processor 22, ACH processing system 10 enables client senders 30 and ACH processor 40 to be agnostic regarding the protocols, file types, and/or other communication system and methods used for processing ACH transactions.

Transfer station 20 receives, processes, and/or communicates one or more files 25 between or among one or more components of ACH processing system 10. In particular embodiments, transfer station 20 receives file 25 generated by client sender 30 and/or other components of ACH processing system 10, determines a particular file type, converts file 25 to a second file type, transmits file 25 to an appropriate component of ACH processing system 10, and/or performs an action based on the contents of file 25. In particular embodiments, transfer station 20 represents a mainframe computer system that receives and/or processes file 25 associated with particular ACH transactions. In general, however, transfer station 20 may include any appropriate combination of hardware, software, and/or encoded logic suitable to perform the described functionality. In some embodiments, ACH processor may comprise a general-purpose personal computer (PC), a Macintosh, a workstation, a Unix-based computer, a server computer, or any suitable processing device. Moreover, the functions and operations described above may be performed by a pool of transfer stations 20.

In some embodiments, transfer station 20 receives file 25 in a first file type or format and translates file 25 into a second file type or format readable and/or processable by other components of ACH processing system 10. In particular embodiments, transfer station 20 interconnects and functions as a translator between ACH processor 40 and client sender 30 side applications, services, and channels.

In particular embodiments, transfer station 20 may include file processor 22. In particular embodiments, file processor 22 represents an interface between ACH processor 40 and other systems included in ACH processing system 10. File processor 22 may process any suitable type of file 25 with any type of ACH processor 40. In particular, file processor 22 may be agnostic regarding file type and content of file 25. In particular embodiments, file processor 22 includes a predefined process for handling a particular transaction associated with a particular file 25, which enables file processor 22 to route any file 25 to a relevant ACH processor 40. The predefined process may be configured in a configuration file on file processor 22. When file processors 22 determines the particular type of file 25, the configuration file may designate how to process file 25 and to which ACH processor 40 to transmit it. File processor 22 may comprise any suitable combination of hardware, software, and/or interface as part of or separate from transfer station 20 to initiate, receive, or process any relevant ACH transaction.

In particular embodiments, file processor 22 includes a file landing zone into which file 25 is received and/or deposited by client sender 30. A file landing zone may comprise all or a portion of a memory in file processor 22. File processor 22 may include a server side deamon that, when activated, periodically scans a file landing zone in file processor 25 to determine whether a file 25 has been received. If file processor 22 determines that file 25 has been received, a server side deamon process may generate a particular processing thread to process file 25. In some embodiments, each file 25 is processed by a particular thread suitable to process the received file 25. Upon receipt of file 25, file processor may log and wrap file 25 with two transmission wrapper records, and initiate file delivery to ACH Processor 40.

File 25 represents one or more ACH requests and/or processes intended to be presented to ACH processor 40. Client 30 may generate file 25 to request a particular ACH transaction at ACH processor 40. In some embodiments, file 25 represents a plain text file that includes one or more ACH transactions. For example, file 25 may include one or more direct deposit payroll transactions originated by client sender 30. File 25 may also represent a binary representation of one or more ACH requests and or processes of any suitable format. In certain embodiments, file 25 represents record types and elements included in file 25 and may be defined by a National Automated Clearing House Association (“NACHA”) standard.

Client senders 30a-d (which may be referred to individually as “client sender 30” or collectively as “client senders 30”) represents a computer system that may generate, initiate, transmit and/or process any type of ACH transaction. Client sender 30 may comprise any suitable combination of hardware, software, and/or interface. In particular embodiments, client sender 30 represents a Point of Sale payment system, an ACH origination channel, a Business Bridge or Systar system, client reporting channels, ACXIS Blocks, and/or on-us posting of SDRs. In some embodiments, client sender 30 may be operated by an organization external to and that communicates with an organization that operates transfer station 20 and/or ACH processor 40. In some embodiments, client sender 30 may be operated by an organization that operates ACH processor 40 and/or transfer station 20.

ACH processor 40 receives file 25 from transfer station 20 and processes ACH transactions and/or requests included in file 25. In particular embodiments, ACH processor 40 represents a mainframe computer system that processes ACH transactions. In general, however, ACH processor 40 may include any appropriate combination of hardware, software, and/or encoded logic suitable to perform the described functionality. In some embodiments, ACH processor may comprise a general-purpose personal computer (PC), a Macintosh, a workstation, a Unix-based computer, a server computer, or any suitable processing device. The functions and operations described above may be performed by a pool of ACH processors 40. Although particular embodiments support processing of ACH and/or NACHA formatted files, ACH processor 40 may represent one or more systems that process financial transaction files of any type or format, including but not limited to a NACHA format. Thus, particular embodiments of ACH processing system 10 supports files 25 of any type or format received or transmitted from any relevant component of ACH processing system 10.

Networks 50a and 50b represent any number and combination of wireline and/or wireless packet-switched or circuit-switched networks suitable for data transmission. Client senders 30, transfer station 20, file processor 22, and/or ACH processor 40 are communicatively coupled via one or more networks 70. In particular embodiments, client senders 30 may communicatively couple to transfer station 20 and/or file processor 22 via network 50a. Transfer station 20 and/or file processor 22 may communicatively couple to ACH processors 40 via network 50b. Networks 50a and 50b may, for example, communicate internet protocol packets, frame relay frames, asynchronous transfer mode cells, and/or other suitable information between network addresses. Networks 50 and 50b may include one or more intranets, local area networks, metropolitan area networks, wide area networks, cellular networks, all or a portion of the Internet, and/or any other communication system or systems at one or more locations.

In the illustrated embodiment, transfer station 20, file processor 22, client senders 30, and ACH processor 40 are represented as different components of ACH processing system 10. However, the functions of transfer station 20, file processor 22, client senders 30, and ACH processor 40 may be performed by any suitable combination of one or more servers or other components at one or more locations. Additionally, transfer station 20 and file processor 22 may represent the same component within ACH processing system 10. In the embodiment where the various components are servers, the servers may be public or private servers, and each server may be a virtual or physical server. The server may include one or more servers at the same or at remote locations. Also, transfer station 20, file processor 22, client senders 30, and ACH processor 40 may include any suitable component that functions as a server. Additionally, ACH processing system 10 may include any appropriate number of transfer station 20, file processor 22, client senders 30, and ACH processor 40. Any suitable logic may perform the functions of ACH processing system 10 and the components within system 10.

In an example operation, client sender 30 initiates an ACH transaction by transmitting one or more files 25 to transfer station 20. In certain embodiments, transfer station 20 and/or file processor 22 may begin processing files 25 as files 25 arrive in a designated file landing zone associated with file processor 22. In particular, file processor 22 may periodically analyze designated areas of a file system for particular patterns associated with one or more file types, such as, for example, a type of file name and/or type of data sets included in file 25. In some embodiments, client senders 30 may transmit files 25 that include a file type or pattern which are recognizable as a trigger. File processor 22 may determine whether a received file 22 includes an exact data set name and/or specific attributes to trigger processing of file 25.

In some embodiments, transfer station 20 and/or file processor 22 prioritizes a plurality of received files 25 to determine a sequencing of processing. Prioritization may be based on the particular client sender 30, the type of transactions included in file 25, and/or any other factors or considerations. Upon selecting a particular file 25 to process, file processor 22 determines a file type associated with file 25, and determines an appropriate component of ACH processing system 10 to process it. In particular embodiments, file processor 22 generates a thread based on file 25 to process the received file 25. Prior to transmitting file 25 to a selected ACH processor 40, file processor 22 may perform appropriate file translation and/or formatting to enable a particular ACH processor 40 to process file 25.

Once file processor 22 selects a particular file 25, file processor 22 may determine which component of ACH pressing system 10 to process file 25 based on the file attributes of file 25. In particular, file processor 22 may select and transmit file 25 to ACH processor 40 based on file attributes of file 25. Moreover, file 25 may be truncated at file processor 22 for local processing (i.e. file 25 is a file that file processor 22 uses itself). In some embodiments, client sender 30 may represent an ACH application and file 25 may be transmitted outbound from the ACH application to an internal ACH application within an organization.

To ensure transactions occur as requested by client sender 30, transfer station 20 may guarantee delivery of file 25 using ACH system protocols. In particular, for certain embodiments of ACH processing system 10, it is necessary to keep track of and/or ensure completion of ACH and/or other transactions requested by client sender 30. In previous systems, a file transaction may fail without alerting a user or other component to a failure. Particular embodiments of ACH processing system 10 may guarantee delivery and/or completion of requested transaction by utilizing a portion of file 25. For example, in some embodiments, file 25 may include a count of the number of records or elements in the file 25. ACH processor 40 may read a number of records or elements in file 25, count the number of records or elements, and determine how many records or elements file 25 reports in a particular portion of file 25. If the number of determined records or elements and the number of reported records or elements match, ACH processor 40 may send back to file processor 22 and/or client sender 30 confirmation that the number of records or elements match. Thus, transfer station 20 provides a data center, protocol, platform and agnostic way of providing file transfers between components of ACH processing system 10. This two way handshake may be facilitated by a header record and a trailer record in file 25. In particular embodiments, a header record identifies a type of file, and a trailer record reports the number of records or elements.

In particular embodiments, file processor 22 also has the ability to retransmit file 25 to ACH processor 40 or other relevant component of ACH processing system 10 a particular ACH transaction or operation that has failed. For example, file processor 22 can store file 25 in memory 204. Upon receiving notification from ACH processor 40 that a particular transaction requested in file 25 has failed, file processor 22 may retrieve file 25 from memory 204 and resend or redeliver file 25 from file processor 22 to ACH processor 40. Additionally, if ACH processor 40 is unavailable for a period of time, file processor 22 may determine a relative priority of a plurality of files 25 in memory 204. Each file 25 may have a default priority, associated with a particular transaction and/or client sender 30. An operator of ACH processing system 10 may override a default priority, enabling an operator to customize which files 25 are processed first, in the event a component of ACH processing system 10 is unavailable for a period of time. Thus, file processor 22 may retransmit files 25 to ACH processor 40 according to a specified and/or default priority.

In some cases, transfer station 20 may be interfacing directly with client sender 30. Transfer station 20 may also interface with PARITER, ACH systems, transaction routing systems within an organization, report loading systems, and interfaces to transmission management software. An ACH transaction processed by transfer station 20 may include report data, transaction data, and/or a customer origination transaction.

Transfer station 20 and/or file processor 22 may also keep track of any file 25 that it receives and/or processes. Transfer station 20 and/or file processor 22 may store in memory 204 a record of receiving a particular file 25, may store the received file 25 for a specified time, may keep track of a destination to which it sent file 25 (such as for example, ACH processor 40), any translations or conversions performed on file 25, to how many different destinations it transmitted file 25, what the status of the one or more transactions requested by file 25 is, how many attempts were made to transmit file 25, and/or how many times file processor 22 received file 25 over a particular period of time.

By performing protocol, file format, and interconnectivity translational operations, ACH processing system 10 provides numerous operational benefits. For example, ACH processing system 10 enables ACH processor 40 to be agnostic with respect to the protocol, system and type of file sent by client sender 30. Transactions and/or applications processed by ACH processing system 10 may include a Demand Deposit Application (DDA), information reporting, web channels, viewing and reporting transactions, and/or ACH origination. ACH processor 40 may represent, but is not limited to, a PARITER ACH processing system. Transfer station may process file 25 by determining whether file 25 conforms to NACHA regulations, in-clearing file 25 through “on-bank” processing, or DDA processing and/or out-clearing through the Federal Reserve or EPN processing. ACH processing may involve interfacing with numerous other heterogeneous applications. Utilizing ACH processing system 10, existing applications operated by client sender 30 may coexist with any ACH processor 40. Moreover, transfer station 20 enables transparency across all non-ACH applications. In this way, non-ACH applications operated by client sender 30 may be agnostic with respect to which particular ACH processor 40 handles a particular transaction initiated by client sender 30.

Further, in particular embodiments, transfer station 20 represents middleware between non-ACH applications and ACH processor 40. For example, in some embodiments, transfer station 20 represents an overarching umbrella framework that defines middleware used to interface between client systems 30 and ACH processor 40. In particular embodiments, transfer station 20 may operate to ensure that transactions and/or file 25 are not lost. ACH processing system 10 may also be agnostic with respect to the communication protocols utilized by components of ACH processing system 10. For example, transfer station 20 may communicate with other components ACH processing system 10 via file transfer protocol (FTP), secure file transfer protocol (secure FTP), Network Data Mover protocol (NDM), and/or any other host-to-host connection. Moreover, transfer station 20 decouples each ACH processor 40 entity from semantics internal to client senders 30.

In some embodiments, transfer station 20 includes file processor 22, which routes file 25 to an appropriate ACH processor 40 and ensures no file 25 gets lost. Previously, applications operated by client sender 30 would transfer a file to an ACH system without receiving any type of confirmation or acknowledgment. However, this type of arrangement does not scale in situations in which there are numerous types of applications and numerous types of ACH processors. Utilizing ACH processing system 10, client sender 30 transmits file 25 to transfer station 20, which determines how to interact with ACH processor 40 and/or other client senders 30. Transfer station 20 determines intrinsic data or metadata associated with file 25, what type of data file 25 represents, and an appropriate component of ACH processing system 10 to process file 25. Thus, particular embodiments of ACH processing system 10 buffers the need for change between any application and an ACH processor 40. Moreover, ACH processing system 10 allows for local processing to transform data into an appropriate format suitable for processing by ACH processor 40. As a result, system 10 may provide numerous operational benefits. Nonetheless, particular embodiments may provide some, none, or all of these operational benefits, and may provide additional operational benefits.

Modifications, additions, or omissions may be made to ACH processing system 10 without departing from the scope of the present disclosure. For example, when a component of system 10 determines information, the component may determine the information locally or may receive the information from a remote location. As another example, in the illustrated embodiment, client senders 30, transfer station 20, file processor 22, and ACH processor 40 are represented as different components of ACH processing system 10. However, the functions of client senders 30, transfer station 20, file processor 22, and ACH processor 40 may be performed by any suitable combination of one or more servers or other components at one or more locations. In the embodiment where the various components are servers, the servers may be public or private servers, and each server may be a virtual or physical server. The server may include one or more servers at the same or at remote locations. Also, client senders 30, transfer station 20, file processor 22, and ACH processor 40 may include any suitable component that functions as a server. Additionally, ACH processing system 10 may include any appropriate number of client senders 30, transfer station 20, file processor 22, and ACH processor 40. Any suitable logic may perform the functions of system 10 and the components within ACH processing system 10.

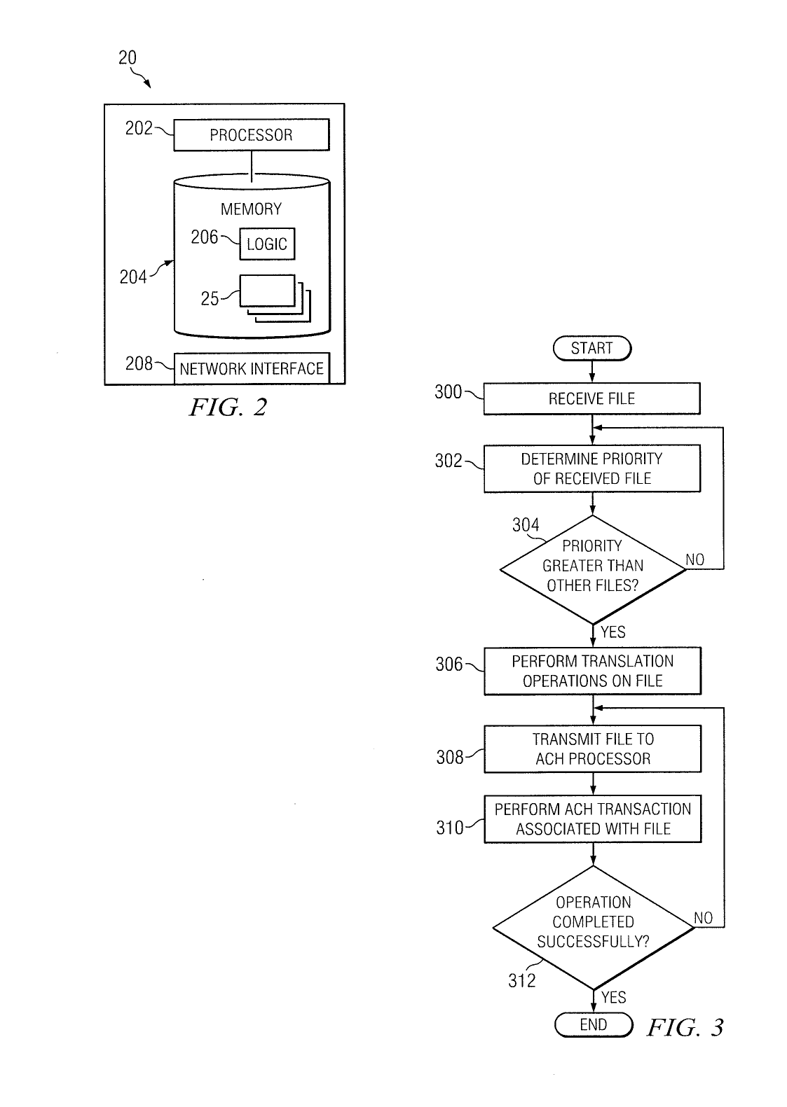

FIG. 2 is a block diagram illustrating aspects of transfer station 20 discussed above with respect to FIG. 1. As discussed above, transfer station 20 receives file 25 from client sender 30, determines type of transaction requested by file 25, and determines a particular ACH processor 40 to process file 25. In particular embodiments, transfer station 20 includes processor 202, memory 204, logic 206, and network interface 208.

Memory 204 comprises any suitable arrangement of random access memory (RAM), read only memory (ROM), magnetic computer disk, CD-ROM, repository, other magnetic or optical storage media, or any other volatile or non-volatile memory device that stores one or more files, lists, tables, or other arrangements of information, such as file 25 received from client 30 prior to transmittal to ACH processor 40. Although FIG. 2 illustrates memory 204 as internal to transfer station 20, it should be understood that memory 204 may be internal or external to transfer station 20, depending on particular implementations. Memory 204 may be separate from or integral to other memory devices to achieve any suitable arrangement of memory devices for use in ACH processing system 10.

Memory 204 is further operable to store logic 206. Logic 206 generally comprises rules, algorithms, code, tables, and/or other suitable instructions for receiving, storing, generating, and/or transmitting relevant information to and/or from client sender 30 and/or ACH processor 40.

Memory 204 is communicatively coupled to processor 202. Processor 202 is generally operable to execute logic to perform operations described herein. Processor 202 comprises any suitable combination of hardware and software implemented in one or more modules to provide the described function or operation.

Network interface 208 communicates information with one or more networks. For example, network interface 208 may communicate with client sender 30 and/or ACH processor 40 over networks 50a and/or 50b through network interface 208. A network may include communication using internet protocol packets, frame relay frames, asynchronous transfer mode cells, and/or other suitable information between network addresses. A network may include one or more intranets, local area networks, metropolitan area networks, wide area networks, cellular networks, all or a portion of the Internet, and/or any other communication system or systems at one or more locations.

FIG. 3 is a flow diagram illustrating an operation in accordance with a particular embodiment of ACH processing system 10. In the illustrated example, operation begins at step 300, with client sender 30 transmitting file 25 to transfer station 20. File 25 represents one or more ACH requests and/or processes intended to be presented to ACH processor 40. Client 30 may generate file 25 to request a particular ACH transaction at ACH processor 40. In some embodiments, file 25 represents a plain text file that includes one or more ACH transactions. For example, file 25 may include one or more direct deposit payroll transactions originated by client sender 30. As another example, file 25 may represent a point-of-sale transaction request. As another example, file 25 may represent a wire transfer request. File 25 may also represent a binary representation of one or more ACH requests and or processes of any suitable format. In certain embodiments, file 25 represents record types and elements included in file 25 and may be defined by a National Automated Clearing House Association (“NACHA”) standard.

At step 302, file processor 22 determines a priority associated with file 25. File processor 22 may determine which files 25 in a queue are a higher relative priority than other files 25 that may have entered the queue earlier. Each file 25 may have a default priority, associated with a particular transaction and/or client sender 30. An operator of ACH processing system 10 may override a default priority, enabling an operator to customize which files 25 are processed first, in the event a component of ACH processing system 10 is unavailable for a period of time. Prioritization may be based on the particular client sender 30, the type of transactions included in file 25, and/or any other factors or considerations.

At step 304 file processor compares a received file 25 to other files 25 stored in memory 204 to determine a relative priority. If a received file 25 has the highest priority, file processor 22 continues processing file 25. If not, file processor 25 processes a highest priority file 25. Upon selecting the received file 25 to process, file processor 22 determines a file type associated with file 25, and determines an appropriate component of ACH processing system 10 to process it. In particular embodiments, file processor 22 generates a thread based on file 25 to process the received file 25.

At step 306, file processor 22 performs appropriate translation operations on file 25. In particular embodiments, client sender 30 and ACH processor 40 may communicate in different file formats, protocols, and/or interfaces. Thus, prior to transmitting file 25 to a selected ACH processor 40, file processor 22 may perform appropriate file translation and/or formatting to enable a particular ACH processor 40 to receive and/or process file 25.

At step 308, ACH processor 40 performs operations based on received file 25. In particular embodiments, file 25 may include one or more requests for ACH processing, including, but not limited to, depositing funds, transferring funds, withdrawing funds, processing payments at a point of sale terminal, and/or any other relevant transaction.

At step 310 file processor 22 determines whether operation completed successfully. In some embodiments, ACH processor 40 communicates to file processor 22 a confirmation that an operation requested in file 25 was or was not completed successfully. Thus, file processor 22 may receive an indication from ACH processor 40 of the status of each transaction requested in file 25. Based on this indication, file processor 22 may determine whether or not one or more operations or transactions requested by file 25 were completed successfully by ACH processor 40.

At step 312 file processor 22 retransmits file 25 to ACH processor 40. In the illustrated embodiment, file processor 22 determines that the transaction requested by file 25 did not complete successfully. Thus, file processor 25 retrieves stored file 25 from memory 204 and retransmits file 25 to ACH processor 40. Operation proceeds by returning to step 310.

The steps illustrated in FIG. 3 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A system for processing an automated clearing house (ACH) transaction comprising:
a memory operable to store one or more files, each of the files including a transaction request for one or more ACH transactions; and
a file processor operable to:
receive a file from a client sender;
select a file from the received file and the plurality of files stored in the memory;
select an ACH processor from a plurality of ACH processors to receive the selected file;
translate the selected file into a format processable by the selected ACH processor; and
transmit the translated file to the selected ACH processor.

2. The system of claim 1, wherein the file processor is operable to select an ACH processor based on at least one of the file attributes of the selected file and the transaction request included in the selected file.

3. The system of claim 1, wherein the file processor is further operable to receive a transaction status message from the selected ACH processor, the transaction status message indicating whether the transaction request included in the received file was completed by the ACH processor.

4. The system of claim 3, wherein the file processor is further operable to retransmit the translated file to the selected ACH processor if the transaction status message indicates that the transaction request included in the received file was not completed by the ACH processor.

5. The system of claim 1, wherein each of the files is associated with a respective priority;
and wherein the file processor is operable to select a file from the received file and the plurality of files stored in the memory based at least in part on the respective priorities of the received file and the plurality of files.

6. The system of claim 1, wherein the file processor is further operable to:
determine, prior to transmitting the file, whether a selected ACH processor is not able to receive the file; and
based on determining that the selected ACH processor is not able to receive the file, store the file in the memory.

7. A method for processing an automated clearing house (ACH) transaction comprising:
receiving one or more files from a client sender, each of the one or more files including a transaction request for one or more ACH transactions;
storing the one or more files in a memory;
selecting a file from the received one or more files stored in the memory;
selecting an ACH processor from a plurality of ACH processors to receive the selected file;
translating the selected file into a format processable by the selected ACH processor; and
transmitting the translated file to the selected ACH processor.

8. The method of claim 7, further comprising selecting an ACH processor comprising selecting an ACH processor based on at least one of the file attributes of the selected file and the transaction request included in the selected file.

9. The method of claim 7, further comprising receiving a transaction status message from the selected ACH processor, the transaction status message indicating whether the transaction request included in the received file was completed by the ACH processor.

10. The method of claim 9, further comprising to retransmitting the translated file to the selected ACH processor if the transaction status message indicates that the transaction request included in the received file was not completed by the ACH processor.

11. The method of claim 7, wherein each of the files is associated with a respective priority;
and wherein selecting a file from the one or more received files comprises selecting a file from the one or more received files based at least in part on the respective priorities of the received file and the plurality of files.

12. The method of claim 7, further comprising:
determining, prior to transmitting the file, whether a selected ACH processor is not able to receive the file; and
based on determining that the selected ACH processor is not able to receive the file, storing the file in the memory.

13. A non-transitory computer readable medium encoded with logic, the logic operable, when executed on a processor to:
receive one or more files from a client sender, each of the one or more files including a transaction request for one or more ACH transactions;
store the one or more files in a memory;
select a file from the received one or more files stored in the memory;
select an ACH processor from a plurality of ACH processors to receive the selected file;
translate the selected file into a format processable by the selected ACH processor; and
transmit the translated file to the selected ACH processor.

14. The non-transitory computer readable medium of claim 13, wherein the logic is operable to select an ACH processor based on at least one of the file attributes of the selected file and the transaction request included in the selected file.

15. The non-transitory computer readable medium of claim 13, wherein the logic is further operable to receive a transaction status message from the selected ACH processor, the transaction status message indicating whether the transaction request included in the received file was completed by the ACH processor.

16. The non-transitory computer readable medium of claim 15, wherein the logic is further operable to retransmit the translated file to the selected ACH processor if the transaction status message indicates that the transaction request included in the received file was not completed by the ACH processor.

17. The non-transitory computer readable medium of claim 13, wherein each of the files is associated with a respective priority;
and wherein the logic is operable to select a file from the received file and the plurality of files stored in the memory based at least in part on the respective priorities of the received file and the plurality of files.

18. The non-transitory computer readable medium of claim 13, wherein the logic is further operable to:
determine, prior to transmitting the file, whether a selected ACH processor is not able to receive the file; and
based on determining that the selected ACH processor is not able to receive the file, store the file in the memory.
